(19) United States
(12) Patent Application Publication
(10) Pub. No.: US 2024/0403434 A1
(43) Pub. Date: Dec. 5, 2024

(54) DEVICE OPERATION METHOD, FIRMWARE MANAGEMENT METHOD AND FIRMWARE MANAGEMENT SYSTEM

(71) Applicant: Hangzhou AliCloud Feitian Information Technology Co., Ltd., Hangzhou City (CN)

(72) Inventors: Yuewu LI, Beijing (CN); Baosheng WANG, Beijing (CN)

(21) Appl. No.: 18/685,217

(22) PCT Filed: Feb. 2, 2023
(86) PCT No.: PCT/CN2023/074191

§ 371 Date: Feb. 20, 2024

(30) Foreign Application Priority Data
Feb. 14, 2022 (CN) 202210134527.8

(51) Int. Cl. G06F 21/57

(52) U.S. Cl. CPC G06F 21/572

(57) ABSTRACT

A device operation method, a firmware management method and a firmware management system are disclosed. First firmware data to be loaded by a chip of a first device is acquired from a second device associated with the first device. And the first firmware data is loaded to the chip without going through a local nonvolatile memory of the first device. Therefore, it is not necessary to install the nonvolatile memory such as a flash on the mainboard of the device to store the firmware, and it is also not necessary to install a security chip for verifying the firmware, thus greatly reducing cost of the device.

### CROSS-REFERENCE TO RELATED APPLICATIONS

The present application is a National Stage of International Application No. PCT/CN2023/074191, filed on Feb. 2, 2023, which claims priority to Chinese Patent Application No. 202210134527.8, titled “DEVICE OPERATION METHOD, FIRMWARE MANAGEMENT METHOD AND FIRMWARE MANAGEMENT SYSTEM”, filed to China National Intellectual Property Administration on Feb. 14, 2022. These applications are hereby incorporated by reference in their entireties.

### TECHNICAL FIELD

The present disclosure relates to the technical field of computers, in particular to a device operation method, a firmware management method and a firmware management system.

### BACKGROUND

A server includes a CPU (Central Processing Unit), a BMC (Baseboard Management Controller) and one or more other chips.

As shown in FIG. 1, BIOS FW (BIOS Firmware) needs to be loaded for CPU startup, BMC FW (BMC Firmware) needs to be loaded for BMC startup, and other chips that require firmware (FW) also need to load their dedicated FW to function normally.

All kinds of firmwares on the server are generally stored in a Flash, an EEPROM and other nonvolatile memories, and these firmwares have maintenance requirements such as version upgrade, security verification, device maintenance and replacement.

Taking a BIOS as an example, the main function of the BIOS is to initialize the system hardware resources and boot the operating system. It is the most important firmware on the server. Therefore, the server often makes redundant design for BIOS, that is, having two sets of BIOS ROM as a primary BIOS ROM and a backup BIOS ROM. A security chip is also equipped to verify the security of BIOS firmware to prevent tampering. Similar designs are also applied to the BMC.

All kinds of the firmwares of the server are placed in nonvolatile memory chip of the server mainboard, which brings the following disadvantages.
1. It is difficult to upgrade or downgrade a version. For upgrading the firmware version of a single server, it is necessary to rewrite the nonvolatile memory chip (Flash, etc.) of the server mainboard, which takes a long time and has poor support for updating with power on. For firmware upgrade of a large number of servers on the cloud, it is particularly difficult to manage different types of server firmware upgrade, and the upgrade takes a long time.
2. There are security risks. Although there are dedicated security chips (TPCM, Trusted Platform Control Module) to ensure security of the BIOS, the BMC and other firmware, the use of dedicated security chips also increases cost, and verification on firmware by security chips increases server startup time. Large-scale deployment of security chips in servers on the cloud also leads to maintenance and upgrading workload of the security chips.
3. Firmware needs to be stored in a dedicated Flash chip, or even in redundant dual Flash chips, which increases hardware cost.
4. In addition, BIOS provides a configuration interface for configuring server hardware. As shown in FIG. 2, a general configuration process requires manual operation, and configuration workload is huge for large-scale server BIOS configuration on the cloud.

Therefore, a new firmware management scheme is needed to solve at least one of the above problems in the existing schemes.

### SUMMARY

A technical problem to be solved by the present disclosure is to provide a new firmware management scheme to solve at least one of the above problems in the existing schemes.

According to a first aspect of the present disclosure, a device operation method applied for execution by a first device is provided, the method includes:
acquiring, from a second device associated with the first device, first firmware data required to be loaded by a chip of the first device; and loading the first firmware data into the chip without going through a local nonvolatile memory of the first device.

In an implementation, the step of acquiring, from a second device associated with the first device, first firmware data required to be loaded by a chip of the first device includes: sending a firmware request to the second device associated with the first device; and receiving the first firmware data corresponding to the firmware request sent by the second device, where the first firmware data is pre-stored in the second device, or the first firmware data is acquired by the second device from a firmware resource pool located in a cloud.

In an implementation, the method further includes: receiving second firmware data sent by the second device, where the second firmware data is firmware data corresponding to firmware customization information, where the firmware customization information includes version customization information and/or parameter configuration information, and the firmware customization information is generated for the first device by a firmware management platform; and loading the second firmware data into the chip without going through the local nonvolatile memory of the first device.

In an implementation, the method further includes: sending a downgrade request to the second device; receiving the first firmware data sent by the second device; reloading the first firmware data to the chip without going through the local nonvolatile memory of the first device.

According to a second aspect of the present disclosure, a firmware management method applied for execution by a second device associated with a first device is provided, the method includes: determining whether first firmware data corresponding to a firmware request exists in the second device in response to receiving the firmware request sent by the first device; and acquiring the first firmware data from a firmware resource pool located in the cloud if the first firmware data corresponding to the firmware request does not exist in the second device, and sending acquired first firmware data to the first device.

In an implementation, the method further includes: receiving firmware customization information set for the first device by a firmware management platform located in the cloud, where the firmware customization information includes version customization information and/or parameter configuration information; acquiring second firmware data corresponding to the firmware customization information from the firmware resource pool; and sending acquired second firmware data to the first device.

In an implementation, the method further includes: sending the first firmware data to the first device if the first firmware data corresponding to the firmware request exists in the second device.

In an implementation, the method further includes: performing security verification on the first firmware data before sending the first firmware data to the first device.

According to a third aspect of the present disclosure, a server firmware management system is provided, including: an access device connected with a server; a firmware resource pool and a firmware management platform, where the access device is respectively connected with the firmware resource pool and the firmware management platform, the firmware management platform customizes a version and/or a parameter of a firmware for the server and sends customization information to the access device, the access device acquires firmware data consistent with the version and/or the parameter characterized by the customization information from the firmware resource pool according to the customization information, and sends acquired firmware data to the server, so that the server loads the firmware data into a chip without going through a local nonvolatile memory.

According to a fourth aspect of the present disclosure, a computing device is provided, including: a processor; and a memory having an executable code stored thereon that, when executed by the processor, causes the processor to perform the method as described in the first aspect or the second aspect above.

According to a fifth aspect of the present disclosure, a computer program product is provided, including executable code which, when executed by a processor of an electronic device, causes the processor to perform the method as described in the first aspect or the second aspect above.

According to a sixth aspect of the present disclosure, a non-transitory machine-readable storage medium is provided, which has executable code stored thereon, when the executable code is executed by a processor of an electronic device, causes the processor to execute the method as described in the first aspect or the second aspect above.

Therefore, the present disclosure acquires the first firmware data to be loaded by the chip of the first device from the second device associated with the first device, and loads the first firmware data to the chip without going through the local nonvolatile memory of the first device, so that it is unnecessary to install the nonvolatile memory such as Flash on a mainboard of the device to store the firmware, and it is also unnecessary to install a security chip for verifying the firmware, thereby greatly reducing cost of the device.

### BRIEF DESCRIPTION OF DRAWINGS

The above and other objects, features and advantages of the present disclosure will become more apparent by describing in more detail exemplary embodiments of the present disclosure in conjunction with the accompanying drawings, and in the exemplary embodiments of the present disclosure, like reference numerals generally represent like parts.

FIG. 1 shows a schematic structural diagram of a server.

FIG. 2 shows a schematic diagram of a configuration process of a server BIOS.

FIG. 3 shows a schematic principle diagram of a firmware management method of the present disclosure.

FIG. 4 shows a structural diagram of a server firmware management system according to an embodiment of the present disclosure.

FIG. 5 shows a schematic diagram of a management and controlling platform managing the firmware version information of servers in multiple clusters.

FIG. 6 shows a schematic diagram of firmware version upgrade, downgrade and smooth transition.

FIG. 7 shows a schematic structural diagram of a computing device according to an embodiment of the present disclosure.

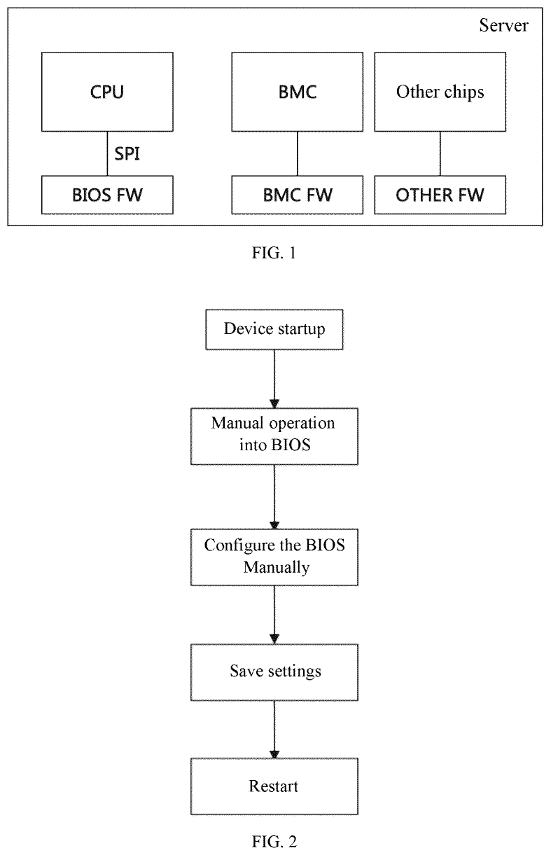

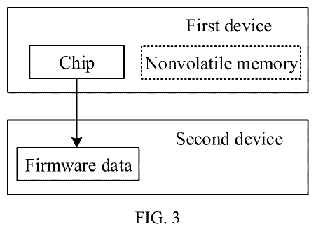

### DESCRIPTION OF EMBODIMENTS

Preferred embodiments of the present disclosure will be described in more detail below with reference to accompanying drawings. Although preferred embodiments of the present disclosure are shown in the drawings, it should be understood that the present disclosure can be embodied in various forms and should not be limited by the embodiments set forth herein. Rather, these embodiments are provided so that this disclosure will be thorough and complete, and will fully convey the scope of the present disclosure to those skilled in the art.

Considering that there are many defects when the firmware is stored in the local nonvolatile memory (such as Flash, EEPROM, etc.) of a device (such as a server), the present disclosure proposes to transfer the firmware from the local nonvolatile memory of the device to the outside of the device for storage, so that it is not necessary to install the nonvolatile memory such as Flash on the mainboard of the device to store the firmware, or to install a security chip for verifying the firmware, thus greatly reducing cost of the device.

FIG. 3 shows a principle schematic diagram of a firmware management method of the present disclosure.

Referring to FIG. 3, a first device refers to a device including one or more chips, such as a server.

The chips (such as CPU, BMC, etc.) in the first device are in need of loading dedicated firmware data to function normally.

The second device is a device set for the first device and capable of data transmission with the first device.

The first device and the second device can be connected by a bus.

Firmware data that the chip in the first device needs to load in order to function normally can be stored in the second device.

The firmware data in the second device can be pre-stored or acquired from the cloud in real time.

When the chip in the first device needs to load firmware data, the first device can acquire first firmware data that the chip of the first device needs to load from the second device and load the first firmware data to the chip without going through the local nonvolatile memory of the first device.

Loading the first firmware data into the chip without going through the local nonvolatile memory of the first device means that the first firmware data loaded into the chip is not from the local nonvolatile memory of the first device. That is, the first firmware data is not acquired and loaded from the local nonvolatile memory of the first device.

It should be noted that since the firmware data to be loaded by the chip in the first device is provided by the second device, the local nonvolatile memory for storing the firmware data may not be set in the first device. Or the local nonvolatile memory may still be set in the first device, but the local nonvolatile memory may no longer store the firmware data. Or the local nonvolatile memory can still be set in the first device, and the nonvolatile memory can store the firmware data, except that the chip preferentially loads the firmware data acquired from the second device without going through the local nonvolatile memory when it needs to load the firmware data, and loads the firmware data from the local nonvolatile memory when the firmware data cannot be acquired from the second device.

In a case that the first device is provided with a local nonvolatile memory, the firmware data stored in the local nonvolatile memory can be pre-stored, or acquired from the second device and stored, or backed up from the chip of the first device.

The first firmware data is loaded to the chip, that is, the first firmware data is loaded by the chip. The firmware data is equivalent to program code, and loading the first firmware data is equivalent to running the program code. By loading the first firmware data, corresponding (bottom layer) functions can be provided for the chip, so that the chip can function normally based on the functions provided by the firmware.

When the chip in the first device needs to load the firmware data, the first device or the chip in the first device can send a firmware request to the second device and receive the first firmware data corresponding to the firmware request sent by the second device.

When the second device receives the firmware request from the first device, it can first determine whether the first firmware data corresponding to the firmware request exists in the second device. The firmware request may include a type of the requested firmware, and the second device may determine whether firmware data corresponding to the requested firmware type is cached in the local firmware cache.

If the first firmware data corresponding to the firmware request exists in the second device, the second device can directly send the first firmware data to the first device, or it can first perform a security verification on the first firmware data and then send the first firmware data to the first device after the security verification is passed. The security verification on the first firmware data may refer to checking whether the first firmware data is integrated and available, and whether the first firmware data is tampered, etc.

If the first firmware data corresponding to the firmware request does not exist in the second device, the second device can acquire the first firmware data from a firmware resource pool located on the cloud and send the acquired first firmware data to the first device. After the second device acquires the first firmware data from the firmware resource pool, it can store the first firmware data in a memory (such as a firmware cache) in the second device, where the memory can be a volatile memory or a nonvolatile memory.

The firmware resource pool can include all kinds of firmware of different devices, and different release versions of the same type of firmware can be included to ensure flexible operation of firmware upgrade and downgrade. The firmware resource pool is invisible to users, and the first device has no permission to write into the firmware resource pool, so that the firmware in the firmware resource pool can be guaranteed not to be tampered with.

The present disclosure can also set up a firmware management platform for managing and controlling versions and/or parameters of the firmware loaded by the first device. The firmware management platform can be located on the cloud. The firmware management platform can manage the version and/or parameters of the firmware loaded by the first device by managing and controlling the version and/or parameters of the firmware in the second device.

Specifically, the firmware management platform can generate firmware customization information adapted to the first device according to a type, specification and other information of the first device. The firmware customization information may include version customization information and/or parameter configuration information. Version customization information is used to characterize the version of the firmware, and parameter configuration information is used to characterize specific configuration of some or all of the parameters of the firmware that need to be set in a specific version. The firmware management platform can send the firmware customization information to the second device, and the second device acquires firmware data corresponding to the firmware customization information (that is, second firmware data) from the firmware resource pool, and sends the second firmware data to the first device, and then the first device loads the second firmware data to the chip without going through the local nonvolatile memory of the first device.

The second firmware data and the first firmware data may refer to different firmware versions of the same type of firmware or different parameter configurations of the same firmware version. In a case that the second firmware data and the first firmware data refer to different parameter configurations of the same firmware version, the second firmware data and the first firmware data can also be regarded as firmware of different versions.

For a scenario where a large number of the first device needs to customize some BIOS parameters, the firmware management platform personalizes the BIOS parameters of the first device, so that only BIOS version of the parameter configuration is provided by the firmware resource pool, and the firmware management platform sends the parameters to the second device as needed, without manual configuration.

If there is a problem in the process of loading the second firmware data, the first device can send a downgrade request to the second device, receive previously loaded firmware data (i.e. the first firmware data) sent by the second device, and then the first device reloads the first firmware data to the chip without going through the local nonvolatile memory of the first device. Therefore, the firmware can be downgraded from a version corresponding to the second firmware data to a version corresponding to the first firmware data. Wherein, the first firmware data (i.e. a previous version) can be kept in the second device or the firmware resource pool.

Taking the first device being a server as an example, the process of managing server firmware in the present disclosure will be exemplarily explained.

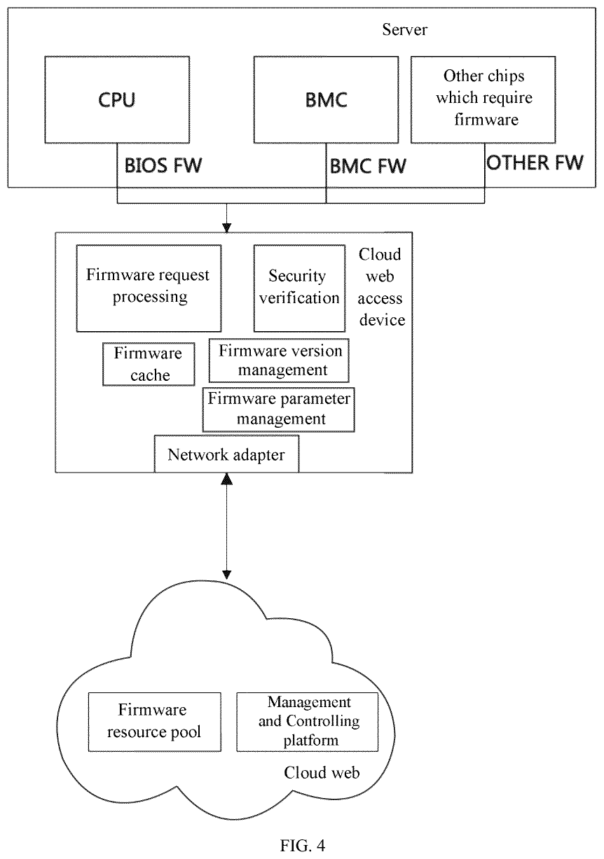

FIG. 4 shows a structural diagram of a server firmware management system according to an embodiment of the present disclosure.

As shown in FIG. 4, the server firmware management system can include an access device, a firmware resource pool and a management and controlling platform.

The access device corresponds to the second device mentioned above. The management and controlling platform corresponds to the firmware management platform mentioned above.

The server can include a CPU, a BMC and other chips that requires firmware.

The server can be connected with the access device through a bus.

The access device is respectively connected with the firmware resource pool and the firmware management platform. Firmware resource pool and the management and controlling platform can be set on the cloud web (that is, at the cloud). Therefore, the access device can also be referred as a cloud web access device. The cloud web access device includes a firmware request processing module, a security verification module, a firmware cache module, a firmware version management module, a firmware parameter management module, a network adapter and other functional modules. The cloud web access device can access the cloud web through the network adapter. Accessing to the cloud web is equivalent to accessing the firmware resource pool and the management and controlling platform in the cloud web.

When the chip in the server needs to load the firmware, the server can initiate a firmware request to the cloud web access device. The firmware request processing module in the cloud web access device can search a local firmware cache according to a type of the server and a type of the requested firmware. If found, data will be fetched from the local firmware cache and submitted to the security verification module for verification. If the verification is passed, the firmware data is transmitted to the server. If not found, the firmware is requested from the firmware resource pool. After the requested firmware is loaded into the firmware cache, it can be verified by the security verification module, and the firmware data will be transmitted to the server if it passes the verification.

The management and controlling platform can manage firmware parameters and firmware versions in cloud web access devices. Specifically, the management and controlling platform customizes the version and parameters of the firmware according to the type and specifications of the server, and sends the customization information to the cloud web access device accessed by the corresponding server. The firmware version management module and the firmware parameter management module in the cloud web access device are responsible for receiving and saving information sent by the management and controlling platform.

A firmware version upgrade only requires to add a new version to the cloud web firmware resource pool, and the management and controlling platform releases new version information to the cloud web access equipment connected with the corresponding cluster server. And the management and controlling platform can send the version information to some cloud web access devices to realize management on smooth transition, and the management and controlling platform can downgrade to a previous version in time when the new version has problems.

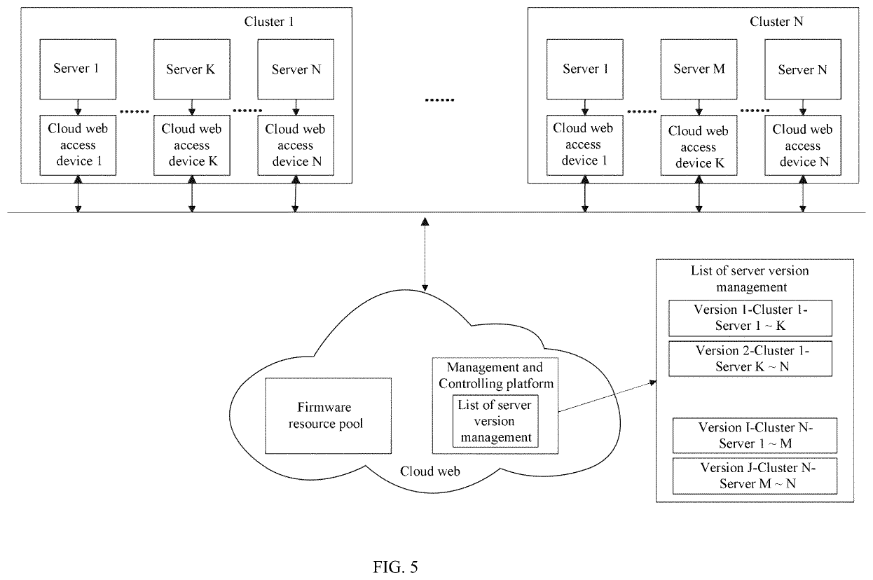

FIG. 5 shows a schematic diagram of the management and controlling platform managing the firmware version information of servers in a plurality of clusters.

Referring to FIG. 5, the management and controlling platform can maintain a list of server version management, which can include the firmware version of each server in each cluster. In an implementation, the list can also include parameter configuration information of each server under a corresponding firmware version. That is, the management and controlling platform can manage the firmware version and firmware parameters of each server in each cluster at the same time.

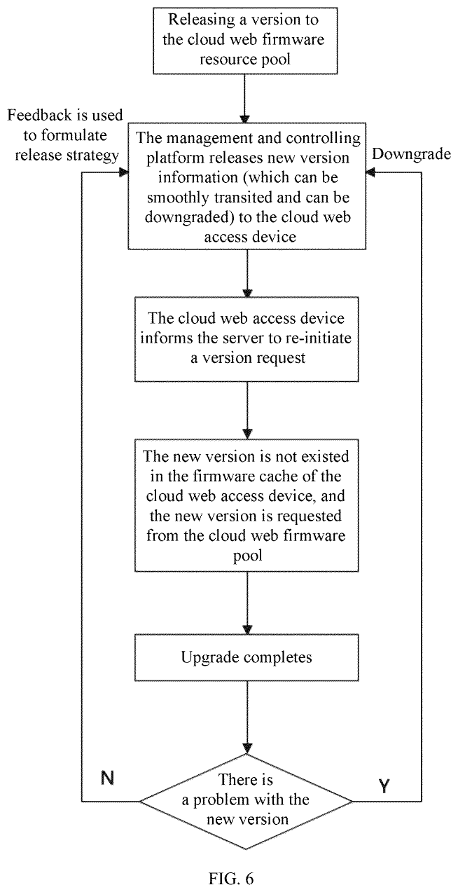

FIG. 6 shows a schematic diagram of firmware version upgrade, downgrade and smooth transition.

Referring to FIG. 6, in response to release of the new version to the cloud web firmware resource pool, the management and controlling platform can issue new version information (which can be smoothly transited and downgraded) to the cloud web access devices which required to be upgraded.

After receiving the new version information, the cloud web access device can notify the server to re-initiate a version request.

After receiving the version request, the cloud web access device can determine whether the new version is in the firmware cache of the cloud web access device. If the new version is not existed in the firmware cache of the cloud web access device, the cloud web access device can request the firmware of the new version from the cloud web firmware resource pool, and then send the firmware of the new version to the server, and the server can upgrade by loading the firmware of the new version.

If there is no problem with the new version, success information can be fed back to the management and controlling platform through the cloud web access device, so that the management and controlling platform can formulate a release strategy of the new version according to feedback information.

If there is a problem with the new version, it can be downgraded to a previous version. For specific downgrade process, please refer to relevant description above.

That is, the present disclosure achieves pooling of firmware versions through unified management of firmware versions of servers (servers on the cloud) on the cloud. It has the following advantages: 1. there is no need to install a nonvolatile memory such as Flash on a server mainboard to store the firmware, and there is no need to install a security chip for verifying the firmware, thus greatly reducing cost. 2. For a scenario where a large number of servers need to customize certain BIOS parameters, only a BIOS version of the parameter configuration needs to be provided by the cloud web firmware resource pool, and the parameters can be sent to the cloud web access device by the management and controlling platform as required. 3. Firmware resource pool effectively ensures security of the firmware. 4. For upgrade and downgrade of the firmware version, it is only required to publish a new version to the cloud web firmware resource pool, and the management and controlling platform will issue the new version command to the cloud web access device according to need with smooth transition.

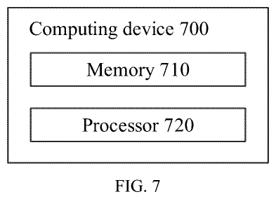

FIG. 7 shows a schematic structural diagram of a computing device that can be used to implement the device operation method or the firmware management method according to an embodiment of the present disclosure.

Referring to FIG. 7, a computing device 700 includes a memory 710 and a processor 720.

The processor 720 may be a multi-core processor or may include multiple processors. In some embodiments, the processor 720 may include a general main processor and one or more dedicated secondary processors, such as a graphics processing unit (GPU), a digital signal processor (DSP) and the like. In some embodiments, the processor 720 may be implemented using a customized circuit, such as an application specific integrated circuit (ASIC) or a Field Programmable Gate Arrays (FPGA).

The memory 710 may include various types of storage units, such as system memory, read-only memory (ROM), and permanent storage device. Among them, ROM can store static data or instructions needed by the processor 720 or other modules of the computer. The permanent storage device can be a read-write storage device. The permanent storage device can be a nonvolatile storage device that will not lose the stored instructions and data even if the computer is powered off. In some embodiments, the permanent storage device adopts a mass storage device (e.g., a magnetic or optical disk, a flash memory). In other embodiments, the permanent storage device may be a removable storage device (e.g., a floppy disk, an optical drive). The system memory can be a read-write storage device or a volatile read-write storage device, such as a dynamic random access memory. System memory can store some or all instructions and data needed when the processor is operating. In addition, the memory 710 can include any combination of a computer-readable storage media, including various types of semiconductor memory chips (DRAM, SRAM, SDRAM, a flash memory, a programmable read-only memory), and magnetic disks and/or optical disks can also be used. In some embodiments, the memory 710 may include removable storage devices that can be read and/or written, such as a compact disc (CD), a read-only digital versatile disc (e.g. DVD-ROM, dual-layer DVD-ROM), a read-only Blu-ray disc, an ultra-density disc, a flash memory card (e.g. SD card, min SD card, Micro-SD card, etc.), a magnetic floppy disk, etc. The computer-readable storage media do not contain carrier waves and instantaneous electronic signals transmitted by wireless means or wired means.

The memory 710 stores executable code, which, when processed by the processor 720, can cause the processor 720 to execute the above-mentioned device operation method or firmware management method.

The device operation method, the firmware management method, the device and the system according to the present disclosure have been described in detail above with reference to the attached drawings.

Furthermore, the method according to the present disclosure can also be realized as a computer program or computer program product, which includes computer program code instructions for executing the above steps defined in the above method of the present disclosure.

Alternatively, the present disclosure can also be implemented as a non-transitory machine-readable storage medium (or a computer-readable storage medium, or a machine-readable storage medium), on which executable code (or computer program, or computer instruction code) is stored, and when the executable code (or computer program, or computer instruction code) is executed by a processor of an electronic device (or a computing device, a server, etc.), the processor is caused to perform various steps of the above method according to the present disclosure.

Those skilled in the art will further appreciate that the various illustrative logical blocks, modules, circuits, and algorithm steps described in connection with the disclosure herein may be implemented as electronic hardware, computer software, or combinations of both.

The flowcharts and block diagrams in the drawings show the architecture, functions and operations of possible implementations of systems and methods according to various embodiments of the present disclosure. In this regard, each block in the flowchart or block diagram may represent a module, a program segment or a part of code, and the module, the program segment or the part of code contains one or more executable instructions for implementing specified logical functions. It should also be noted that in some alternative implementations, the functions marked in the blocks may occur in a different order than those marked in the drawings. For example, two consecutive blocks may actually be executed substantially in parallel, and they may sometimes be executed in the reverse order, depending on functions involved. It should also be noted that each block in the block diagrams and/or flowcharts, and combinations of blocks in the block diagrams and/or flowcharts, can be implemented by a dedicated hardware-based system that performs specified functions or operations, or implemented by a combination of dedicated hardware and computer instructions.

Embodiments of the present disclosure have been described above, and the above description is illustrative, not exhaustive, and is not limited to the disclosed embodiments. Many modifications and changes will be obvious to those skilled in the art without departing from the scope and spirit of the illustrated embodiments. The terminology used herein is chosen to best explain the principles of various embodiments, practical application or improvement to technology in the market, or to enable those skilled in the art to understand various embodiments disclosed herein.

1. A device operation method applied for execution by a first device, the method comprising:
acquiring, from a second device associated with the first device, first firmware data required to be loaded by a chip of the first device; and
loading the first firmware data into the chip without going through a local nonvolatile memory of the first device.

2. The method according to claim 1, wherein the step of acquiring, from a second device associated with the first device, first firmware data required to be loaded by a chip of the first device comprises:
sending a firmware request to the second device associated with the first device; and
receiving the first firmware data corresponding to the firmware request sent by the second device, wherein the first firmware data is pre-stored in the second device, or the first firmware data is acquired by the second device from a firmware resource pool located in a cloud.

3. The method according to claim 1, further comprising:
receiving second firmware data sent by the second device, wherein the second firmware data is firmware data corresponding to firmware customization information, wherein the firmware customization information comprises at least one of version customization information or parameter configuration information, and the firmware customization information is generated for the first device by a firmware management platform; and
loading the second firmware data into the chip without going through the local nonvolatile memory of the first device.

4. The method according to claim 3, further comprising:
sending a downgrade request to the second device;
receiving the first firmware data sent by the second device; and
reloading the first firmware data to the chip without going through the local nonvolatile memory of the first device.

5. A firmware management method applied for execution by a second device associated with a first device, the method comprising:
determining whether first firmware data corresponding to a firmware request exists in the second device in response to receiving the firmware request sent by the first device; and
acquiring the first firmware data from a firmware resource pool located in a cloud if the first firmware data corresponding to the firmware request does not exist in the second device, and sending acquired first firmware data to the first device.

6. The method according to claim 5, further comprising:
receiving firmware customization information set for the first device by a firmware management platform located in the cloud, wherein the firmware customization information comprises at least one of version customization information or parameter configuration information;
acquiring second firmware data corresponding to the firmware customization information from the firmware resource pool; and
sending acquired second firmware data to the first device.

7. The method according to claim 5, further comprising:
sending the first firmware data to the first device if the first firmware data corresponding to the firmware request exists in the second device.

8. The method according to claim 7, further comprising:
performing security verification on the first firmware data before sending the first firmware data to the first device.

9. A server firmware management system, comprising:
an access device connected with a server;
a firmware resource pool; and
a firmware management platform,
wherein the access device is respectively connected with the firmware resource pool and the firmware management platform,
the firmware management platform customizes at least one of a version or a parameter of a firmware for the server and sends customization information to the access device,
the access device acquires firmware data consistent with at least one of the version or the parameter characterized by the customization information from the firmware resource pool according to the customization information, and sends acquired firmware data to the server, so that the server loads the firmware data into a chip without going through a local nonvolatile memory.

10. A computing device comprising:
a processor; and
a memory having an executable code stored thereon that, when executed by the processor, causes the processor to perform the method according to claim 1.

11. (canceled)

12. A non-transitory machine-readable storage medium having an executable code stored thereon that, when executed by a processor of an electronic device, causes the processor to execute the method according to claim 1.

13. The computing device according to claim 10, wherein the executable code is executed by the processor to cause the processor to further execute the following operations:
sending a firmware request to the second device associated with the first device; and
receiving the first firmware data corresponding to the firmware request sent by the second device, wherein the first firmware data is pre-stored in the second device, or the first firmware data is acquired by the second device from a firmware resource pool located in a cloud.

14. The computing device according to claim 10, wherein the executable code is executed by the processor to cause the processor to further execute the following operations:
receiving second firmware data sent by the second device, wherein the second firmware data is firmware data corresponding to firmware customization information, wherein the firmware customization information comprises at least one of version customization information or parameter configuration information, and the firmware customization information is generated for the first device by a firmware management platform; and
loading the second firmware data into the chip without going through the local nonvolatile memory of the first device.

15. The computing device according to claim 14, wherein the executable code is executed by the processor to cause the processor to further execute the following operations:
sending a downgrade request to the second device;
receiving the first firmware data sent by the second device; and
reloading the first firmware data to the chip without going through the local nonvolatile memory of the first device.

16. A computing device comprising:
a processor; and
a memory having an executable code stored thereon that, when executed by the processor, causes the processor to perform the method according to claim 5.

17. The computing device according to claim 16, wherein the executable code is executed by the processor to cause the processor to further execute the following operations:
receiving firmware customization information set for the first device by a firmware management platform located in the cloud, wherein the firmware customization information comprises at least one of version customization information or parameter configuration information;
acquiring second firmware data corresponding to the firmware customization information from the firmware resource pool; and
sending acquired second firmware data to the first device.

18. The computing device according to claim 16, wherein the executable code is executed by the processor to cause the processor to further execute the following operation:
sending the first firmware data to the first device if the first firmware data corresponding to the firmware request exists in the second device.

19. The computing device according to claim 18, wherein the executable code is executed by the processor to cause the processor to further execute the following operation:
performing security verification on the first firmware data before sending the first firmware data to the first device.

20. The non-transitory machine-readable storage medium according to claim 12, wherein the executable code is executed by the processor to cause the processor to further execute the following operations:
sending a firmware request to the second device associated with the first device; and
receiving the first firmware data corresponding to the firmware request sent by the second device, wherein the first firmware data is pre-stored in the second device, or the first firmware data is acquired by the second device from a firmware resource pool located in a cloud.

21. A non-transitory machine-readable storage medium having an executable code stored thereon that, when executed by a processor of an electronic device, causes the processor to execute the method according to claim 5.
